(19) United States
(12) Patent Application Publication
(10) Pub. No.: US 2016/0141128 A1
(43) Pub. Date: May 19, 2016

(54) TEMPERATURE-DEPENDENT SWITCH

(71) Applicant: Thermik Geraetebau GmbH, SONDERSHAUSEN (DE)

(72) Inventors: Michael KIRCH, SONDERSHAUSEN (DE); René NEUMANN, BADRA (DE); Hans-Christian LIEHR, SANGERHAUSEN (DE)

(21) Appl. No.: 14/938,895

(22) Filed: Nov. 12, 2015

(30) Foreign Application Priority Data
Nov. 18, 2014 (DE) 10 2014 116 888.7

(51) Int. Cl. H01H 37/54; H01H 11/04; H01H 37/04

(52) U.S. Cl. CPC H01H 37/54; H01H 37/04; H01H 11/04; H01H 2037/5463

(57) ABSTRACT

A temperature-dependent switch has a housing whereon a first and at least one second connection surface are arranged for the galvanic attachment of connection leads. Within the housing a temperature-dependent switching mechanism is arranged, which produces or opens an electrically conductive connection between the two connection surfaces depending on the temperature of said switching mechanism. The connection leads are connected via the inner ends thereof to the connection surfaces by one-sided spot welding.

### RELATED APPLICATION

This application claims priority to German patent application DE 10 2014 116 888, filed Nov. 18, 2014 and published in German language, which is incorporated herein by reference.

### BACKGROUND OF THE INVENTION

### Field of the Invention

The present invention relates to a temperature-dependent switch which has a temperature-dependent switching mechanism and a housing receiving the switching mechanism, wherein a first and a second connection surface are provided externally on the housing for the electrical connection of connection leads, the temperature-dependent switching mechanism producing or opening an electrically conductive connection between the two connection surfaces depending on the temperature of said switching mechanism, to at least one of the connection surfaces a connection lead being secured via its inner end in an materially bonded manner.

A switch of this type is known from DE 10 2009 030 353 B3.

Further, temperature-dependent switches of this type are frequently known from the prior art. They are used to protect electrical devices, such as hairdryers, motors of lye pumps, flat irons, etc., against overheating and/or excessively high current.

For this purpose, the known temperature-dependent switches are connected in series to the device to be protected in the power supply circuit thereof, such that the operating current of the device to be protected flows through the temperature-dependent switch. The switch is also mounted on the device to be protected such that it adopts the temperature of the device to be protected.

The known temperature-dependent switches comprise a temperature-dependent switching mechanism that, depending on its temperature, opens or closes an electrical connection between two connection surfaces provided externally on the housing of the switch. For this purpose, a bimetal part is generally provided in the switching mechanism, which bimetal part deforms abruptly from its low-temperature position into its high-temperature position when its switching temperature is reached and in so doing generally lifts a movable contact part from a fixed contact part.

The fixed contact part is connected to one of the two connection surfaces, whereas the movable contact part cooperates with the second connection surface either via the bimetal part or a snap disk or snap spring associated with the bimetal part.

Designs in which the bimetal part carries a contact bridge that directly produces an electrical connection between two connection surfaces are also known.

Examples of temperature-dependent switches of this type are described in document DE 10 2009 030 353 B3, already mentioned at the outset, in DE 41 39 091 C2, DE 198 16 807 A1, DE 26 44 411 A and further intellectual property rights of the applicant, and therefore reference can be made to these intellectual property rights with regard to further details.

With the use of the known switches it must often be ensured that the switches are electrically insulated with respect to the electrical device to be protected so that no short circuits occur, these being undesirable.

The known switches specifically have an electrically conductive housing lower part, which is formed as a pot and receives the temperature-dependent switching mechanism. The electrically conductive housing lower part is closed by a cover part, which is likewise electrically conductive and is fixed with intermediate positioning of an insulating film on the housing lower part by flanging of the edge of the lower part onto the cover part. The first connection surface is provided on the cover part, whereas the second connection surface is provided on the base, the side wall or the edge of the housing lower part holding the cover part.

Connection leads, generally either flexible connection strands or rigid terminal lugs, are now connected in a materially bonded manner, i.e. soldered on or welded on, to these two connection surfaces, wherein the strands or terminal lugs are then used for the further connection of the known temperature-dependent switches.

The pre-fabricated switches thus provided with strands or terminal lugs are then provided with a cap or a shrink cap in order to electrically insulate the switches vis-à-vis the environment.

In the case of the switch known from DE 41 39 091 C2, the connection leads are formed as relatively rigid sheet metal plates that were riveted via their inner ends to the connection surfaces. The switch with the rivet points and the inner ends of the sheet metal plates is then molded by a low-pressure epoxy resin. Due to the riveting and the molding with the thermoset, a connection that is robust and can withstand on-going mechanical loading shall be ensured between the sheet metal plates and the housing of the switch, on which the connection surfaces are formed.

However, in the case of the known switch it is disadvantageous that the riveting of the sheet metal plates is time-consuming and poses the risk that the housing is subject to deformations during the riveting process. Due to the extremely small dimensions of the temperature-dependent switches, even the smallest of deformations of the housing may mean that the switch no longer closes and/or opens reliably.

It is also disadvantageous that the riveting must be performed prior to the final assembly of the housing. Here, there is then the problem that the edge of the lower part cannot be readily flanged onto the fitted-on cover part on account of the terminal lug already secured to the cover part. Thus, a manufacturing process must be used for the manufacture of this known switch that is different from that used for switches in which the terminal lugs or connection strands are electrically and mechanically connected to the finished assembled and tested switches.

In the case of the switch known from document DE 10 2009 030 353 B3 mentioned at the outset terminal lugs soldered on via their inner ends to the connection surfaces are used as connection leads, wherein the free ends of the terminal lugs are formed as plug-in terminals. The switches and the inner ends of the terminal lugs are then surrounded jointly by an insulating, sintered protective layer.

Due to the joint sheathing or encasing of the switch, the connection surfaces and the inner ends of the terminal lugs with the protective layer, a structurally stable connection is produced that can then be sufficiently mechanically loaded without impairing the quality of the electrical connection.

However, in particular when the free ends of the connection leads have to be welded to lines or external terminal points for example on devices to be protected, problems may occur with the soldered connections during the subsequent assembly of the switch in or on the device to be protected. These specifically often are not heat-resistant enough to always withstand the subsequent welding of the free ends of the terminal lugs without sustaining damage.

The soldered connections may become soft as a result of the intense heating of the terminal lugs during the welding processes, such that there is a risk that the geometric position of the terminal lugs changes and/or the electrical connection between the inner ends of the terminal lugs and the connection surfaces on the housing of the switch suffers, and may even be interrupted, i.e. the soldered connection becomes cold.

DE 10 2009 030 353 B3, however, also mentions that the inner ends of the terminal lugs can also be welded on to the connection surfaces. The welding attempts performed previously by the applicant, however, have been unsuccessful because the heat development directly at the cover part means that the movable contact part and the fixed contact part are welded to one another or are at least modified in terms of their geometry such that the switches manufactured in this way no longer switch or at least no longer switch reliably. Furthermore, the heat infiltrating the interior of the housing during the welding process may cause the snap disks to be affected, such that their necessary switching properties change inadmissibly.

A further disadvantage with this known switch can be considered the complex final manufacturing step, in which the sintered protective layer is applied.

### SUMMARY OF THE INVENTION

In view of the above, it is one object of the present invention is to improve the known switches in such a way that the above-mentioned disadvantages are reduced or completely avoided.

In the case of the known switch this and other objects are achieved in that the inner end of the connection lead is welded on to the at least one connection surface by at least one weld spot, which has preferably been produced by one-sided spot welding.

The invention also relates to a method for manufacturing a temperature-dependent switch, comprising the following steps:
a) providing a temperature-dependent switch, which externally on its housing comprises a first and a second connection surface for the electrical connection of connection leads as well as, within the housing, a temperature-dependent switching mechanism, which produces or opens an electrically conductive connection between the two connection surfaces depending on the temperature of said switching mechanism,
b) providing at least one connection lead, which comprises an inner end for connection to one of the two connection surfaces, and
c) connecting the inner end of the at least one connection lead to the connection surface by one-sided spot welding.

One-sided spot welding, which in the English-speaking area is also referred to as parallel gap welding, is a form of conductive resistance welding in which the two welding electrodes are brought into contact from one side for example with a surface of one of the two parts to be connected. The welding current thus flows from one of the two welding electrodes in part through the upper part and in part through the lower part and then back into the other welding electrode. The two parts are thus interconnected by two “associated” weld spots.

It is also known to place one welding electrode on the upper side of the upper part and to place the second welding electrode beside the upper part on the upper side of the lower part, i.e. on the face on which the upper part rests. The two parts are thus interconnected only by one weld spot.

Parts can thus be interconnected of which only the upper part and possibly the bearing surface thereof on the lower part are accessible for the welding electrodes.

One-sided resistance welding is described for example in DE 10 2007 020 211 A1, U.S. Pat. No. 3,478,190 A and the datasheet “Resistance Welding-Parallel Gap Welding Basics”, which can be downloaded via the web page www.microjoining.com.

The inventors of the present application have now found that this form of resistance welding is also unexpectedly suited for welding connection leads on to housings of temperature-dependent switches once the switches have already been fully assembled.

The welding current flowing here through part of a wall of the housing does not cause any damage to the switch, but ensures a mechanically robust, electrically safe and temperature-resistant connection between the connection lead and the connection surface.

The connection lead may therefore now be formed as a terminal lug that at its free end can be welded to lines or contact regions without the connection of the inner end to the switch being impaired. In particular, it is no longer necessary to surround the switch connected to the connection leads with a protective layer, which for example is sintered, in order to ensure a connection that structurally is stable enough to then be sufficiently mechanically loadable.

The free end of the terminal lug welded on to the switch in accordance with the invention may also be designed as a crimp terminal, plug terminal or for surface mounted technology (SMT) connection. According to the finding of the inventors, the manipulations then necessary when the switch is finally being assembled on the device to be protected likewise do not cause the connection of the inner end of the terminal lug to the switch to be impaired.

The new switch can be provided by way of example in accordance with the invention with a terminal lug on the cover part that is bent and provided at its free end with a contact face for SMT in such a way that the switch can be assembled as a surface mounted device (SMD) in accordance with reel technology (belt and coil) and can be applied using pick and place SMD automatic placement machines to a printed circuit board and assembled there and for example can be contacted in reflow methods.

The base of the lower part of the housing then serves directly as a second connection surface, which is contacted directly on the printed circuit board, thus providing the second connection to the switch. This connection technology is now available in accordance with the invention because the new switch for the above-mentioned reasons does not have to be provided with a protective layer, and therefore the base of the switch can be assembled directly on a printed circuit board. The terminal lug serves here for the attachment of the other connection surface to the printed circuit board.

If the new switch is not further processed as SMD, it can be provided with an insulating sheathing, however this does not have to ensure a mechanically loadable stabilization of the connection between connection lead and housing. An economical shrink cap that can be mounted quickly and easily can therefore be used as sheathing.

The above-described possibilities of the further processing of the new temperature-dependent switch were not possible beforehand for the reasons mentioned at the outset.

According to one object, the inner end of the connection lead comprises at least two lugs, each of which is welded on via a weld spot to the at least one connection surface, wherein the two lugs preferably extend away from each other and are welded on to the at least one connection surface via an associated pair of weld spots, and the two lugs more preferably extend parallel to one another, are separated from one another via a gap, and are welded on to the at least one connection surface via an associated pair of weld spots, wherein the inner end of the connection lead more preferably has four lugs arranged in pairs, each of which lugs is welded on to the at least one connection surface via a weld spot, and each pair of lugs more preferably has a gap that separates the lugs from one another, and the two pairs point away from one another.

With these measures it is advantageous that a connection having 1, 2 or 4 weld points can be produced depending on the geometric, electrical and mechanical requirements.

The gap between two parallel lugs enables a particularly good connection because the welding current flows for the most part from one lug into the wall of the housing of the switch, from there through the base of the lower part or the cover part, and then passes into the second lug. In other words only a small portion of the welding current flows from one lug into the other lug through the inner end of the connection lead. Here, the gap extends between the two lugs over a length that preferably corresponds at least to the width of the inner end transversely to the gap. The width of the gap corresponds approximately to twice the material thickness of the inner end of the connection lead.

The connection lead is in one embodiment formed as a connection strand and in another embodiment as a terminal lug.

The inventors have found that, contrary to expectation, both terminal lugs and connection strands can be welded on to housings of temperature-dependent switches by means of one-sided spot welding.

According to another embodiment, a series resistor is integrated into the connection lead.

Because the connection lead is subsequently welded on to a connection surface from the outside, a series resistor integrated into the connection lead is a simple and economical possibility for providing a switch which has already been assembled and of which the housing is already closed with a current dependence. Here, a good transfer of heat from the series resistor into the housing is ensured by the welded connection.

According to a further embodiment, a self-holding resistor is arranged on the inner end of a first connection lead and is electrically connected via one of its terminals to the connection lead and at its other terminal to a second connection lead.

This is a simple and economical possibility for providing a switch which has already been assembled and of which the housing is already closed with a self-holding function. Here as well, a good transfer of heat into the interior of the housing is also ensured by the welded connection. The self-holding resistor by way of example may be glued or soldered on to the inner end.

In one embodiment, the housing comprises a cover part, on which the first connection surface is formed, and a lower part, at the base of which the second connection surface is formed, wherein the connection lead preferably comprises a terminal lug bent a number of times, which at its inner end is connected to the first connection surface and at its free end has a terminal portion disposed at the height of the second connection surface and extending parallel thereto in the same plane.

The bent terminal lug thus enables the above-described use of the new switch as SMD component and assembly thereof on a printed circuit board, on which board two adjacently arranged terminal regions for the terminal portion of the bent terminal lug and therefore the first connection surface of the switch and for the base of the housing, i.e. the second connection surface of the housing, are provided for this purpose.

In one embodiment of the new method in step c) the inner end of the connection lead is placed on the connection surface and at least one first welding electrode is pressed onto the inner end, wherein preferably in step c) a second welding electrode is pressed onto the inner end or against the connection surface, wherein the inner end of the connection lead more preferably comprises two lugs, and in step c) a welding electrode is pressed onto each lug.

In this way, the inner ends of the connection leads can be welded on to the connection surfaces via one or two associated weld spots.

In another embodiment, in a further step d) a self-holding resistor is fastened on the inner end of one of the connection leads.

Here, it is advantageous that an assembled switch can also be provided optionally with a self-holding function only when it is provided with connection leads.

In a further embodiment, the temperature-dependent switching mechanism comprises a bimetal part, wherein the bimetal part in the closed state of the switch is preferably arranged electrically in series between the connection surfaces, the temperature-dependent switching mechanism more preferably comprising a spring part that in one application in the closed state of the switch is arranged electrically in series between the connection surfaces. The switching mechanism may alternatively comprise a contact bridge, which is carried by the bimetal part of the spring part and in the closed state of the switch is arranged electrically in series between the connection surfaces.

These are the preferred designs of temperature-dependent switches.

Within the scope of the present invention a bimetal part is understood to mean a multi-layered, active, sheet metal plate-shaped component formed from two, three or four inseparably interconnected components having different coefficients of expansion. The connection between the individual layers formed from metals or metal alloys are materially bonded or form-fitted and are achieved for example by rolling.

The bimetal part is here generally formed as a spring clamped at one end or as a loosely placed disk.

When the bimetal part is formed as in document DE 198 16 807 A1 mentioned at the outset as a bimetal spring tongue, it carries at its free end a movable contact part, which cooperates with a fixed contact part. The fixed contact part is electrically connected to a first external terminal, wherein a second external terminal is electrically connected to the clamped-in end of the bimetal spring tongue.

The bimetal spring tongue below its response temperature closes the electric circuit between the two external terminals by pressing the movable contact part against the fixed contact part.

If the temperature of the bimetal spring tongue rises, it starts to stretch and to deform in a slow-action phase until it finally springs back into its open position, in which it lifts the movable contact part from the fixed contact part.

If the bimetal part by contrast is designed as a bimetal disk, it generally cooperates with a spring snap disk, which carries the movable contact part, which cooperates with the fixed contact part in the above-described manner. The spring snap disk is supported at its edge on an electrode, which is connected to the second external terminal. Such a switch is described by way of example in DE 21 21 802 A or DE 196 09 310 A1.

Below its response temperature, the bimetal disk is loosely placed, i.e. is mechanically unloaded. The contact pressure between fixed and movable contact part and therefore the electrical connection between the two external terminals are provided via the spring snap disk. If the temperature of the known temperature-dependent switch rises, the bimetal disk thus passes through a creeping phase, in which it gradually deforms until it then suddenly jumps back into its open position, in which it acts on the spring snap disk in such a way that it lifts the movable contact part from the fixed contact part and therefore opens the known switch.

In the case of the above-described switch with the bimetal spring tongue, current is passed through the bimetal part itself, such that the bimetal part is heated by the current flowing through the switch. The known switch in this way responds not only to external temperature rises, but also responds to an excessively high flow of current.

Switches of this type therefore respond in a temperature-dependent and current-dependent manner.

By contrast, in the case of the switch with bimetal disk and spring snap disk, the bimetal part is always free from current, i.e. is not heated by the flowing current, such that switches of this type switch largely independently of current.

However, switches are also known in which a bimetal spring tongue cooperates with a spring snap part that carries the flowing current, such that with these designs the bimetal spring disk itself does not carry current. Conversely, switches are also known with which merely a bimetal disk is provided, which carries the movable contact part, produces the closing pressure, and through which current is passed.

Lastly, temperature-dependent switches having two external terminals are known, which are each connected to a fixed contact part, wherein an electrically conductive contact bridge is provided, which carries the flowing current when applied against the fixed contact parts.

Switches of this type having a contact bridge are described for example in DE 197 08 436 A1. They are intended for applications in which high nominal currents flow through the switch, which would lead to a heavy loading or inherent heating of a current-conducting spring snap part or bimetal part.

The contact bridge is carried here by a spring snap disk that cooperates with a bimetal disk. When the bimetal disk is below its response temperature, it lies freely without mechanical loading in the switch, and the spring snap disk presses the contact bridge against the fixed contact parts, such that the circuit is closed. If the temperature rises, the bimetal disk snaps from its force-free closed position into its open position, in which it works against the spring snap disk and lifts the contact bridge from the fixed contact parts.

Further advantages will emerge from the description and the accompanying drawings.

It goes without saying that the features specified above and yet to be explained hereinafter can be used not only in the specified combinations, but also in other combinations or in isolation, without departing from the scope of the present invention.

### BRIEF DESCRIPTION OF THE DRAWINGS

Embodiments of the invention are illustrated in the drawing and will be explained in greater detail in the following description. In the drawing:

FIG. 1 shows a schematic, cross-sectional illustration of an embodiment of a temperature-dependent switch that can be used in accordance with the invention;

FIG. 2 shows a schematic illustration of a first example of the one-sided spot welding method;

FIG. 3 shows a schematic illustration of a second example of the one-sided spot welding method;

FIG. 4 shows a schematic illustration of a third example of the one-sided spot welding method;

FIG. 5 shows the switch from FIG. 1 in views from below, from the side and from above, with connection strands welded on in accordance with the method from FIG. 3;

FIG. 6 shows an illustration as in FIG. 5, but with connection strands welded on in accordance with the method from FIG. 4;

FIG. 7 shows the switch from FIG. 1 in views from below, from the side and from above, with lower terminal lug welded on in accordance with the method from FIG. 2, and with upper terminal lug welded on in accordance with the method from FIG. 4;

FIG. 8 shows an illustration as in FIG. 7, but with a further embodiment for the lower terminal lug;

FIG. 9 shows the switch from FIG. 1 in a perspective view from above and an upper terminal lug to be welded on in accordance with the method from FIG. 4 in a perspective view, in an embodiment for SMD assembly;

FIG. 10 shows a switch and terminal lug from FIG. 9 in a side view and plan view; and

FIG. 11 shows the switch from FIG. 8, in which a PTC disk has been glued on to the lower terminal lug in order to provide the switch with a self-holding function.

### DESCRIPTION OF PREFERRED EMBODIMENTS

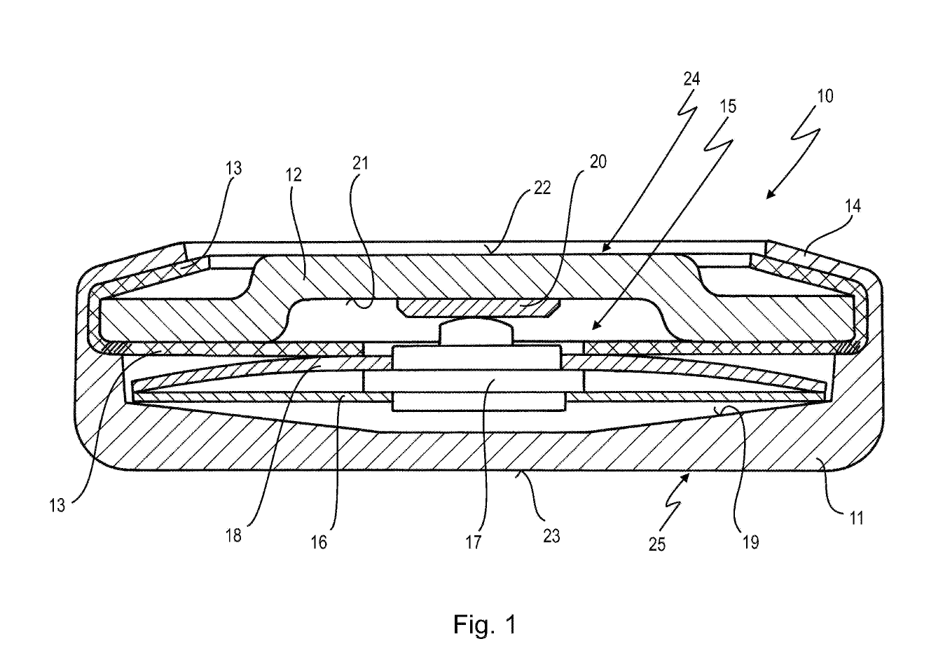

In FIG. 1 a temperature-dependent switch is designated by 10 and comprises an electrically conductive pot-like lower part 11, which is closed by an electrically conductive cover part 12, which is held on the housing lower part 11 by a flanged edge 14 with intermediate positioning of an insulation film 13.

A temperature-dependent switching mechanism 15 is arranged in the housing of the switch 10 formed by the lower part 11 and cover part 12, which switching mechanism comprises a spring snap disk 16, which centrally carries a movable contact part 17, on which a freely placed bimetal disk 18 sits.

The spring snap disk 16 is supported on a base 19 internally on the lower part 11, which is manufactured from electrically conductive material.

The movable contact part 17 is in abutment with a fixed contact part 20, which is provided on an inner side 21 of the cover part 12, which likewise is manufactured from metal.

In this way, the temperature-dependent switching mechanism 15 in the low temperature position shown in FIG. 1 produces an electrically conductive connection between the cover part 12 and the lower part 11, wherein the operating current flows via the fixed contact part 20, the movable contact part 17 and the spring snap disk 16.

The cover part 12 serves via its upper face 24 as first connection surface 22, and the lower part 11 serves via its base 25 as second connection surface 23. Connection strands or terminal lugs can be mounted on these connection surfaces 22, 23.

It is alternatively also possible, instead of the spring snap disk 18, to use directly a bimetal part that carries the movable contact part 17 and generates the closing pressure and thus conducts the operating current when the switch 10 is closed.

Other designs of the temperature-dependent switching mechanism 15 are also conceivable, for example a bimetal spring clamped at one end or a snap spring clamped at one end, which works against a bimetal.

It is also possible to arrange the two connection surfaces 22, 23 adjacently on the cover part 12 and to provide the switching mechanism 15 with a contact bridge that is carried by the bimetal part or the spring part and in the closed state of the switch 10 is arranged electrically in series between the connection surfaces 22, 23.

In the case of the switch 10 from FIG. 1 the cover part 12 is made of electrically conductive material, however it may also be manufactured from insulating material or positive temperature coefficient ceramic (PTC). In these cases the connection surface 22 is formed by a metal layer arranged on the surface 24 and connected through by the cover part 12 to the fixed contact part 20. As a result of the cover part made of PTC material, the switch 10 obtains a self-holding function as is known per se.

For the advantages according to the invention, it is consequently irrelevant whether the switch 10 is formed as in FIG. 1 or as disclosed in the documents mentioned at the outset, the content of said documents hereby being incorporated into the subject of the present application by explicit reference.

If, in the case of the switch 10 from FIG. 1, the temperature of the bimetal disk 18 increases beyond its response temperature, it thus snaps from the convex position shown in FIG. 1 into its concave position, in which it lifts the movable contact part 17 from the fixed contact part 20 against the force of the spring disk 16 and thus opens the circuit.

A temperature-dependent switch 10 of this type is known for example from DE 196 23 570 A1, of which the content is hereby incorporated in the subject matter of the present disclosure by reference.

Once the switch 10 has been assembled as described above, it can be tested for functional efficiency and compliance with its specification and may then be temporarily stored initially until it is used, for example provided with the connection technology in accordance with the invention.

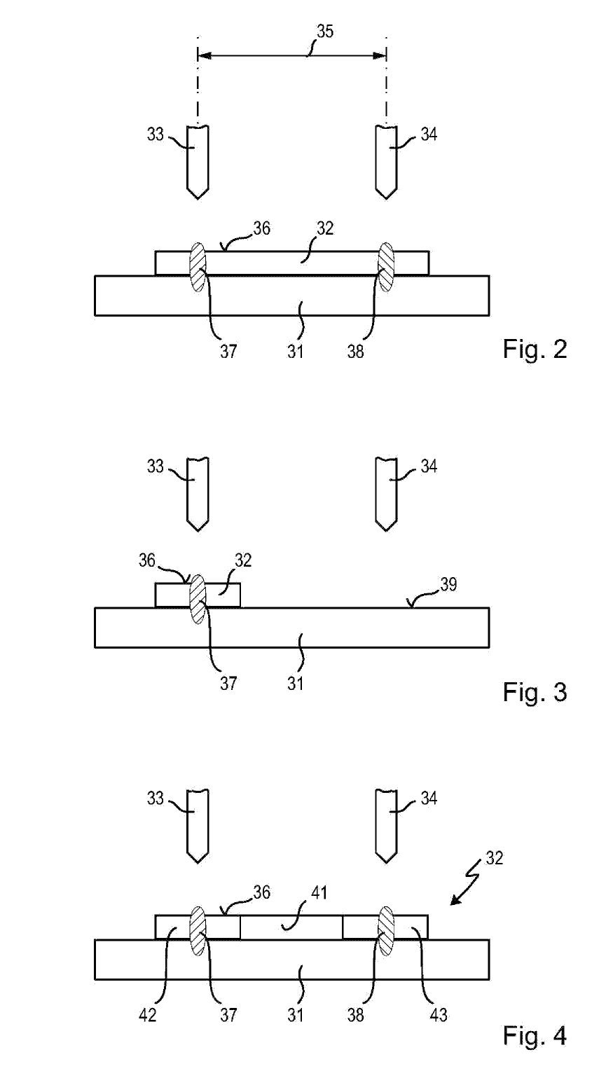

The switch 10 is then provided via one-sided spot welding with connection leads, as is now illustrated in principle in FIGS. 2 to 4.

FIG. 2 shows a first sheet metal part 31, to which a second sheet metal part 32 is to be welded on by means of one-sided spot welding. For this purpose, two welding electrodes 33 and 34 are provided, which are arranged at a distance from one another indicated at 35.

The two welding electrodes 33, 34 are placed onto the surface 36 of the upper sheet metal part 32, whereupon a current then flows both through the upper sheet metal part 32 and through the lower sheet metal part 31 and leads to the formation of weld spots, which are indicated at 37 and 38.

The two sheet metal parts 31 and 32 are thus interconnected via the one-sided spot welding method according to FIG. 2 by an associated pair of weld spots 37 and 38.

FIG. 3 illustrates a situation in which the second welding electrode 34 is not placed onto the upper side 36 of the upper sheet metal part 32, but onto the upper side 39 of the lower sheet metal part 31, such that only one weld spot 37 is produced.

If the distance 35 between the two welding electrodes 33 and 34 on account of geometric conditions cannot be selected to be large enough to allow a sufficient proportion of the flowing welding current to flow through the lower sheet metal part 31, the upper sheet metal part 32 is provided with a gap 41, as illustrated in FIG. 4. The upper sheet metal part 32 then has two lugs 42, 43 extending parallel to one another, which are separated from one another by the gap 41. The gap 41 here has a length transversely to the distance 35 that is large enough for the welding current to flow around the gap 41 only to a small extent.

If the welding electrodes 33 and 34 are now all placed onto the upper side 36 of the upper sheet metal part 32, the welding current flows primarily through the lower sheet metal part 31, which leads to the formation of the associated weld spots 37 and 38.

The one-sided spot welding method described briefly in FIGS. 2 to 4 is known in principle in the prior art, however it has not been used previously to weld on connection leads to connection surfaces on housings of temperature-dependent switches.

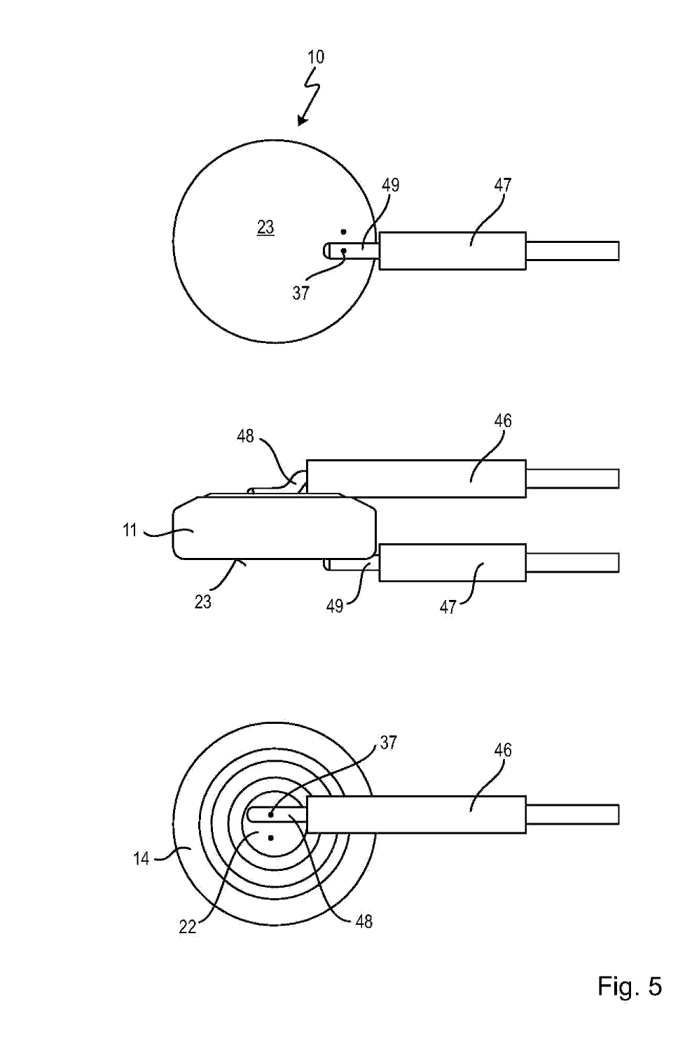

The temperature-dependent switch 10 from FIG. 1 is shown in a first embodiment in FIG. 5 at the top in a view from below, in the middle in a view from the side, and at the bottom in a plan view.

A connection strand 46 and 47 are welded to the upper connection surface 22 and the lower connection surface 23 respectively, wherein the strands are welded on in accordance with the method described above with reference to FIG. 3, such that in each case only one spot weld 37 connects the stripped inner ends 48 and 49 of the connection strands 46 and 47 respectively to the housing of the switch 10.

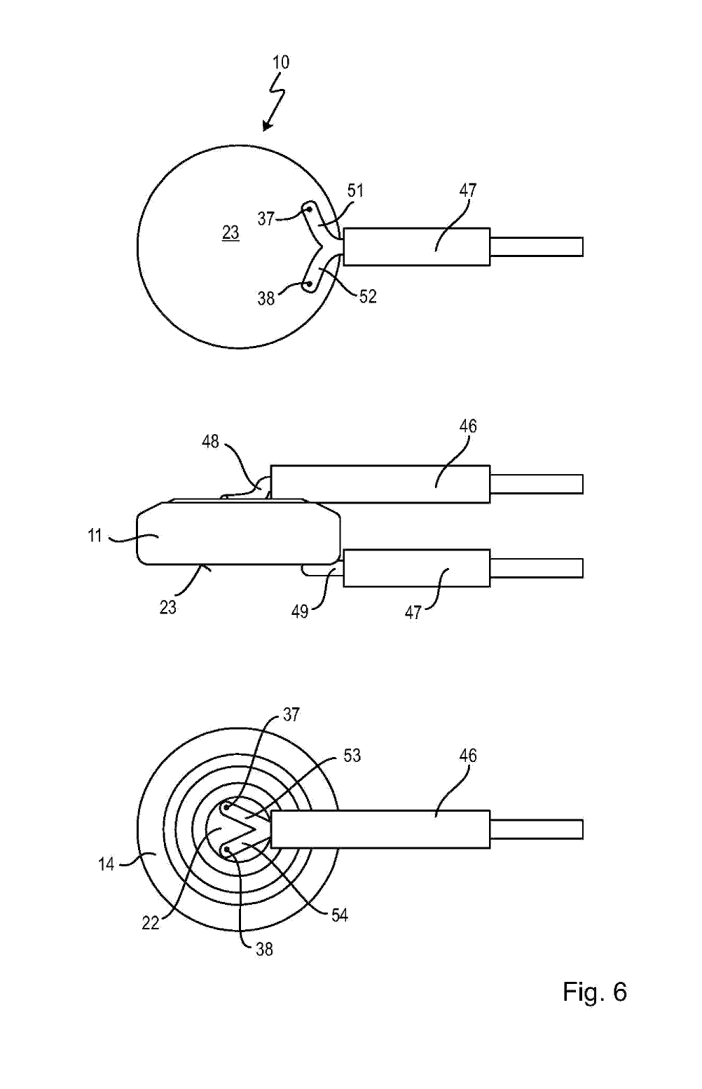

In FIG. 6 the switch 10 is shown in an illustration similar to FIG. 5, two connection strands 46 and 47 again being welded on to said switch.

The stripped inner ends 48, 49 of the connection strands 46 and 47 now extend in a fork-shaped manner away from one another, such that two lugs 51 and 52 and also 53 and 54 are formed and are in each case welded on to the corresponding connection surfaces 22 and 23 respectively by a weld spot 37 and 38. The weld spots 37 and 38 here form an associated pair, as has been described with reference to FIGS. 2 and 4.

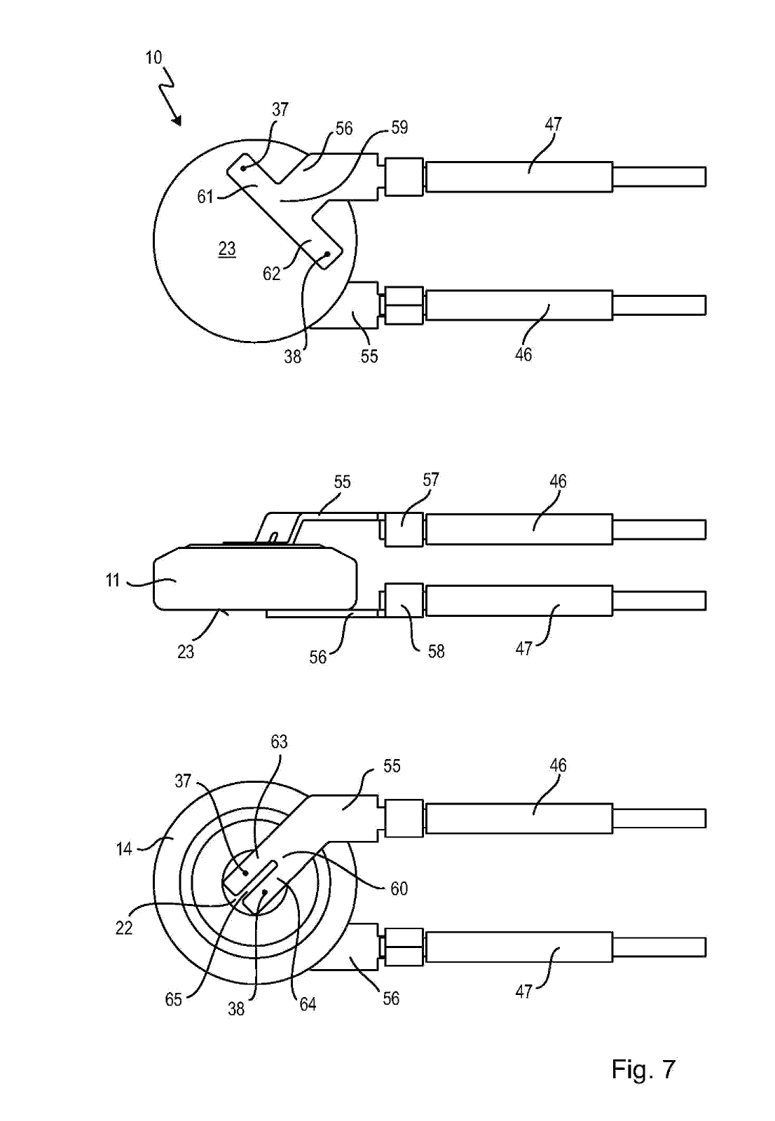

An illustration comparable to FIG. 6 of the temperature-dependent switch 10 is shown in FIG. 7, wherein the connection strands 46 and 47 now are not welded on directly to the connection surfaces 22 and 23, but are attached to terminal lugs 55 and 56 manufactured from sheet metal. The connection strands 46 and 47 can be connected to the terminal lugs 55 and 56 for example by crimping or by plug-in connection. Corresponding crimp ends of the terminal lugs 55 and 56 are shown in FIG. 7 at 57 and 58.

The lower terminal lug 56 comprises, at its inner end 59, two lugs 61 and 62, which extend away from one another in opposite directions and are welded on to the connection surface 23 via a pair of weld spots 37 and 38.

The distance between the weld spots 37 and 38 is of such a size here that the situation of FIG. 2 is produced, where some of the welding current flows through the lower sheet metal part 31, i.e. in this case through the housing lower part 11.

The upper terminal sheet metal 55 by contrast has, at its inner end 60, two lugs 63 and 64 extending parallel to one another, which are separated from one another by a gap 65. The lugs 63 and 64 are welded to the connection surface 22 by weld spots 37 and 38.

The connection according to FIG. 7 at the bottom is consequently produced in accordance with the method described with reference to FIG. 4.

Of course, it is also possible to use the terminal sheet metal 55 for the attachment of the connection strand 46 to the connection surface 23.

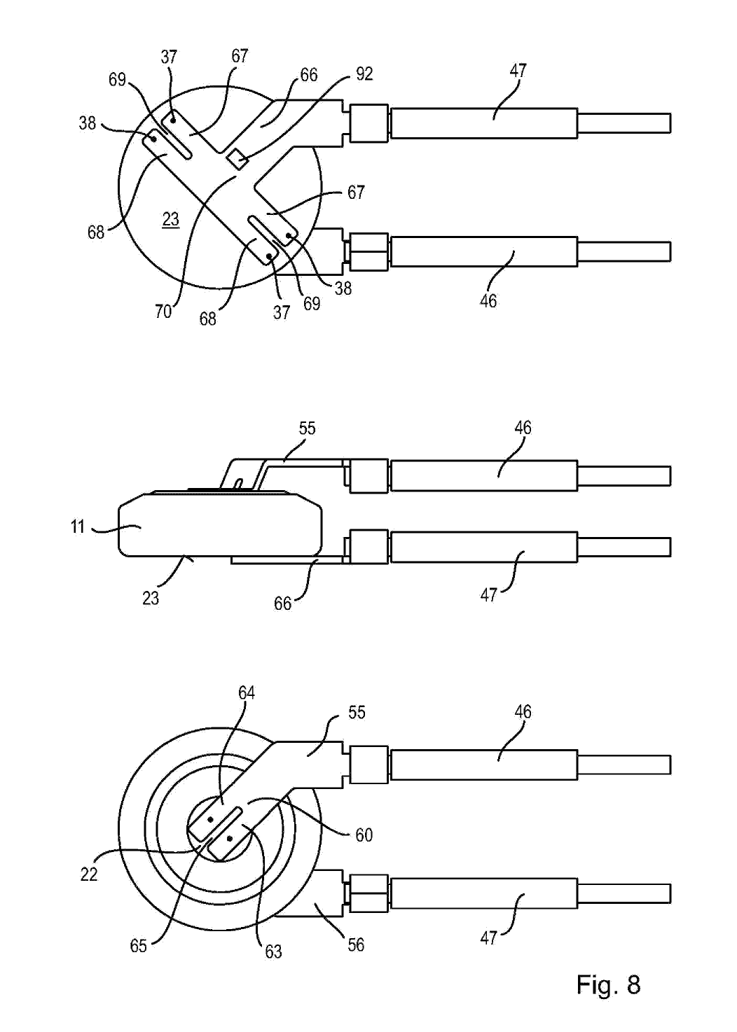

FIG. 8 shows an embodiment similar to that of FIG. 7, only the lower connection strand 47 is now connected to the connection surface 23 via a terminal lug 66, which at its inner end 70 has four lugs 67, 68 arranged in pairs, wherein the lugs 67, 68 of each pair define there between a gap 69 and the two pairs point diametrically away from one another.

Each pair of lugs 67, 68 is connected to the corresponding connection surface 23 via an associated pair of weld sports 37, 38, which are created in accordance with the one-sided spot welding method depicted with reference to FIG. 4.

The mechanical and galvanic materially bonded connection of the connection strands 46 and 47 either directly or via terminal lugs 55, 56 and/or 66 described in this respect is mechanically stable and temperature-resistant in such a way that the connection not only survives the crimping-on or usual manipulations at the connection strands 46 and 47, but the terminal lugs 55, 56, 66 can additionally also be welded on directly to connection strands or further connection surfaces on a device to be protected without the weld spots 37, 38 becoming “soft”, i.e. without impairing the mechanical or electrical connection thereof.

For this reason, it is now also possible for the first time to configure the temperature-dependent switch 10 as an SMD component, such that it can be positioned and then contacted with a conventional SMD automatic placement machine.

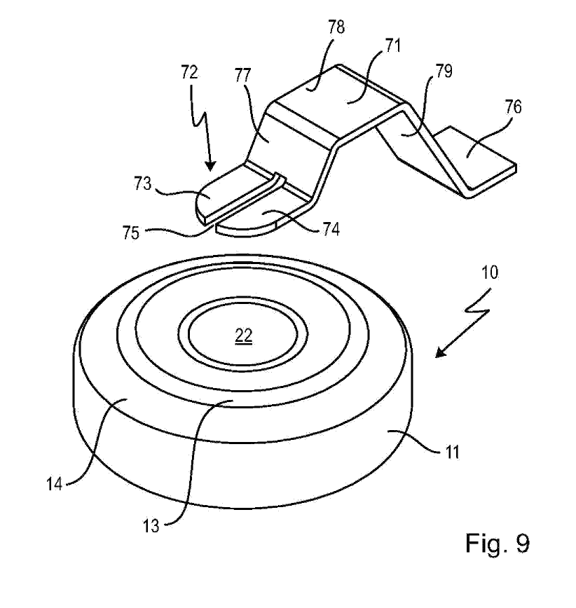

For this purpose, according to FIG. 9 a terminal lug 71 bent a number of times, here four times, which at its inner end 72 has two lugs 73 and 74 separated from one another by a gap 75 extending lengthwise there between, is welded on to the connection surface 22, as has already been shown in FIG. 7 for the terminal lug 55.

The terminal lug 71 has, at its free end 76, a terminal portion arranged at the height of the connection surface 23 and extending parallel thereto in the same plane. Three sheet metal portions 77, 78, 79 are arranged between the inner end 72 and the free end 76 of the terminal lug 71 and are bent relative to one another such that the sheet metal portion 77 firstly extends upwardly at approximately 45° to the inner end 72, the sheet metal portion 78 then extends parallel to the inner end 72 and the outer end 76, and the sheet metal portion 77 is then bent downwardly at 45°, such that it connects the sheet metal portion 78 to the terminal portion.

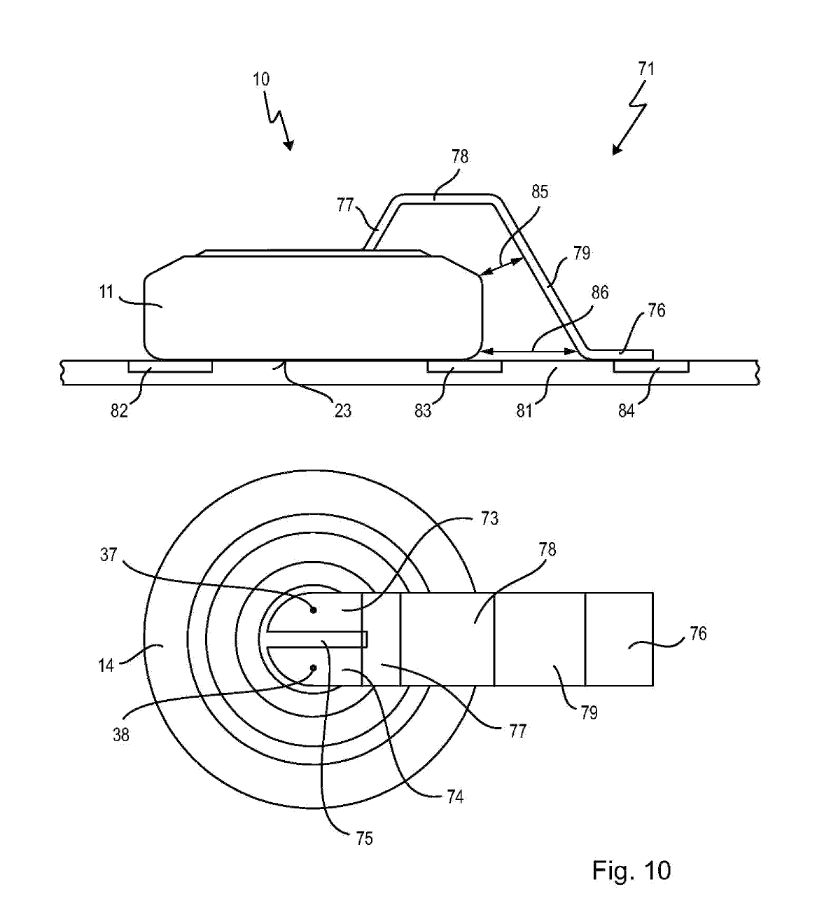

In FIG. 10 the switch 10 from FIG. 9 with the terminal lug 71 is shown at the top in a side view and at the bottom in a plan view.

The switch 10 is placed onto a printed circuit board 81, such that both the connection surface 23 and the free end 76 can now be connected using a conventional reflow method to corresponding contact regions 82, 83, 84 in the printed circuit board 81. Here, the terminal lug 71 ensures both the electrical connection of the connection surface 22 and the mechanical retention of the switch 10.

Due to the bent terminal lug 71, both a sufficient air gap indicated at 85 and a sufficient creeping distance indicated at 86 are maintained with the assembly of the switch 10 on the printed circuit board.

The material of the terminal lugs 55, 56, 66 and 71 is for example nickel silver with a thickness of 0.3 mm, wherein the gaps 65, 69, 75 have a width of 0.5 mm and a length of 2 to 4 mm. The material of the lower part 11 and of the cover part 11 is for example steel of type DC0.1 and may be silver-plated completely or only in the regions serving as connection surfaces 22 and 23.

The material of the lower terminal lugs 56 and 66 may also consist wholly or partially of a resistance alloy, such that a series resistor 92 is integrated into this connection lead, which is indicated in FIG. 8 by dashed region. The terminal lug 56, 66 consequently has a low electrical resistance, such that the terminal lug 56 or 66 heats up as current flows. This leads, at excessively high amperage, to a heating of the lower part 11, such that the switch 10 opens already as a result of the excessively high current, moreover before the device to be protected has itself heated up to such an extent that this leads to a heating of the switch such that this opens as a result of the heat transferred from the device. The lower terminal lug 56 or 66 thus ensures current-dependent switching.

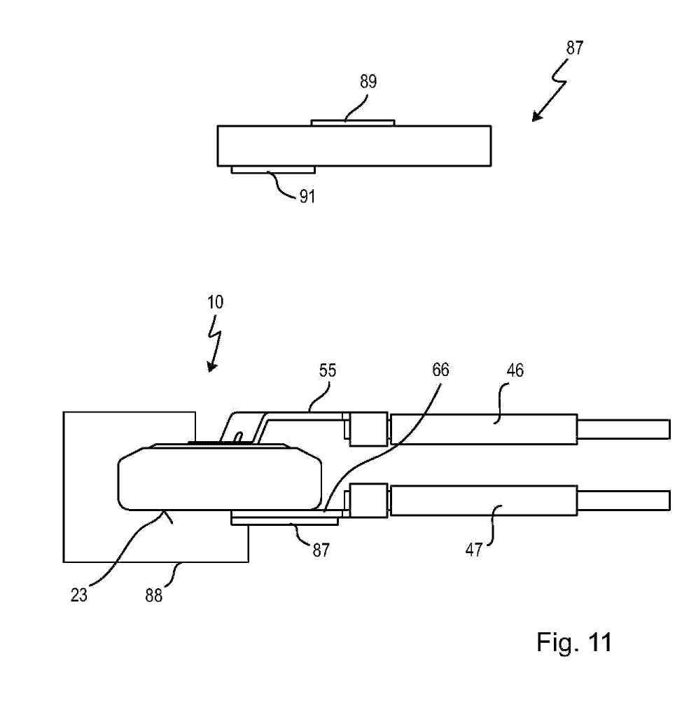

Additionally or alternatively, a self-holding resistor may also be applied externally to the lower terminal lug 56 or 66, as shown very schematically in FIG. 11 for the switch 10 from FIG. 8, which is shown in FIG. 11 in a side view.

A PTC disk 87 illustrated in an enlarged manner at the top in FIG. 11 is glued onto the lower terminal lug 66 and is thus connected electrically conductively via its upper terminal 89 to the lower connection strand 47. The PTC disk 87 is electrically conductively connected at its lower terminal 91 to the upper terminal lug 55 and therefore to the upper connection strand 46 via a schematically indicated electrical connection 88. The self-holding resistor formed by the PTC disk 87 is thus connected electrically parallel to the switching mechanism 15.

When the switch 10 is open the self-holding resistor thus takes on some of the operating current in a manner known per se and holds the switching mechanism 15 at a temperature above the return temperature of the bimetal desk 18 until the current supply of the device to be protected is switched off.

Therefore, what is claimed is:

1. A temperature-dependent switch comprising:
a temperature-dependent switching mechanism and a housing wherein the switching mechanism is arranged,
a first and a second connection surface being provided externally on the housing, a first connection lead being welded at its inner end to said first connection surface by at least one weld spot,
the temperature-dependent switching mechanism producing or opening an electrically conductive connection between the first and second connection surfaces depending on the temperature of said switching mechanism.

2. The switch of claim 1, wherein the inner end of the first connection lead is welded to the first connection surface by one-sided spot welding.

3. The switch of claim 1, wherein the inner end of the first connection lead comprises at least two lugs, each lug being welded to the first connection surface via a weld spot.

4. The switch of claim 3, wherein the inner end of the first connection lead comprises four lugs, said two lugs extend away from one another and are welded to said first connection surface via an associated pair of weld spots.

5. The switch of claim 3, wherein the inner end of the first connection lead comprises four lugs, said two lugs extend parallel to one another, are separated from one another via a gap, and are welded to the first connection surface via an associated pair of weld spots.

6. The switch of 3, wherein the inner end of the first connection lead comprises four lugs arranged in two pairs, each lug being welded to the first connection surface via a weld spot.

7. The switch of claim 6, wherein each pair of lugs comprises a gap which separates the lugs within said pair from one another, said two pairs of lugs point away from one another.

8. The switch of claim 1, wherein the connection lead is formed as a connection strand.

9. The switch of claim 1, wherein the connection lead is formed as a terminal lug.

10. The switch of claim 1, wherein a series resistor is integrated into the connection lead.

11. The switch of claim 1, wherein a self-holding resistor having a first and a second terminal is arranged at the inner end of the first connection lead and is electrically connected via its first terminal to the first connection lead and is electrically connected via its second terminal to a second connection lead.

12. The switch of claim 1, wherein the housing comprises a cover part, on which the first connection surface is formed, and a lower part having on the base whereon the second connection surface is formed, the first connection lead comprising a bent terminal lug having an inner end connected to the first connection surface and having a free end comprising a terminal portion arranged in plane with the second connection surface and extending parallel thereto.

13. The switch of claim 1, wherein the temperature-dependent switching mechanism comprises a bimetal part.

14. The switch of claim 13, wherein the bimetal part in the closed state of the switch is arranged electrically in series between the first and second connection surfaces.

15. The switch of claim 1, wherein the temperature-dependent switching mechanism comprises a spring part.

16. The switch of claim 15, wherein the spring part in the closed state of the switch is arranged electrically in series between the first and second connection surfaces.

17. A method for manufacturing a temperature-dependent switch, comprising the following steps:
a) providing a temperature-dependent switching mechanism and a housing wherein the temperature-dependent switching mechanism is arranged, and providing externally on said housing a first and a second connection surface for electrically connecting a first and a second connection lead, said temperature-dependent switching mechanism producing or opening an electrically conductive connection between said first and second connection surfaces depending on the temperature of said switching mechanism,
b) providing a first connection lead which comprises an inner end for connection to said first connection surface, and
c) connecting said inner end of said first connection lead to said first connection surface by one-sided spot welding.

18. The method of claim 17, wherein in step c) the inner end of said first connection lead is placed on the first connection surface and at least one first welding electrode is pressed onto the inner end.

19. The method of claim 18, wherein in step c) a second welding electrode is pressed onto the inner end of said first connection lead.

20. The method of claim 18, wherein in step c) a second welding electrode is pressed onto the first connection surface beside the inner end of said first connection lead.

21. The method of 19, wherein the inner end of the first connection lead comprises two lugs, and in step c) a welding electrode is pressed onto each of said two lugs.

22. The method of claim 17, wherein in a further step d) a self-holding resistor is fastened on an inner end of one of the connection leads.

23. A temperature-dependent switch comprising:
a temperature-dependent switching mechanism and a housing wherein the switching mechanism is arranged, a first and a second connection surface being provided externally on the housing,
a first connection lead having a first inner end and a second connection lead having a second inner end being attached to said first and second connection surfaces, respectively,
said first inner end being attached to said first connection surface by at least one welding spot,
said second inner end being attached to said second connection surface by at least one welding spot,
the temperature-dependent switching mechanism producing or opening an electrically conductive connection between the first and second connection surfaces depending on the temperature of said switching mechanism.
